(19) United States
(12) Patent Application Publication
(10) Pub. No.: US 2012/0065791 A1
(43) Pub. Date: Mar. 15, 2012

(54) HOME ENERGY MANAGER FOR PROVIDING ENERGY PROJECTIONS

(75) Inventors: John K. Besore, Prospect, KY (US); Michael Beyerle, Pewee Valley, KY (US); Timothy Worthington, Crestwood, KY (US)

(73) Assignee: General Electric Company

(21) Appl. No.: 13/053,392

(22) Filed: Mar. 22, 2011

Related U.S. Application Data
(63) Continuation-in-part of application No. 12/892,130, filed on Sep. 28, 2010.

(51) Int. Cl. G06F 1/26

(52) U.S. Cl. 700/291

(57) ABSTRACT

A home energy management system for providing energy usage and cost projections to a user related to management of a home network is provided. The system comprises a central controller coupled to at least one energy consuming device, the central controller being configured to receive energy consumption data from the at least one energy consuming device, and a user interface comprising a display coupled to the central controller to receive user input data and provide the user with information. The central controller is further configured to use the energy consumption data and user input data to provide the user with one or more of future energy consumption projections, energy saving suggestions, and cost saving suggestion.

### CROSS REFERENCE TO RELATED APPLICATIONS

The present application is a continuation-in-part of U.S. application Ser. No. 12/892,130 (GE 237986), filed Sep. 28, 2010, which is expressly incorporated herein by reference, in its entirety.

### BACKGROUND

The following disclosure relates to energy management, and more particularly to energy management of household consumer appliances, as well as other energy consuming devices and/or home energy systems found in the home. The present disclosure finds particular application to a home energy management system configured to provide predictive guidance to consumers through a communicating consumer control device, such as a home energy manager (HEM).

Many utilities are currently experiencing a shortage of electric generating capacity due to increasing consumer demand for electricity. Currently utilities charge a flat rate, but with increasing cost of fuel prices and high energy usage at certain parts of the day, utilities have to buy more energy to supply customers during peak demand, which causes prices to rise during these times. If peak demand can be lowered, then a potential huge cost savings can be achieved and the peak load that the utility has to accommodate is lessened. In order to reduce high peak power demand, many utilities have instituted time of use (TOU) metering and rates which include higher rates for energy usage during on-peak times and lower rates for energy usage during off-peak times. As a result, consumers are provided with an incentive to use electricity at off-peak times rather than on-peak times and to reduce overall energy consumption of devices at all times.

To take advantage of the lower cost of electricity during off-peak times, systems have been provided that can automatically operate power consuming devices during off-peak hours in order to reduce consumer's electric bills and also to reduce the load on generating plants during on-peak hours. Active and real time communication of energy costs of devices to the consumer enables informed choices of operating the power consuming functions of the devices. Although these systems are capable of being run automatically according to demand period, a user may choose to override the system and run a device normally, or delay the operation of the system for a particular period of time.

Accordingly, it would be beneficial to provide a consumer with information that would help the consumer make an informed decision about the cost impact such an override will incur, to provide an incentive for discretional power use to be moved into the off-peak timeframe and so consumers can balance their level of comfort with a desired savings amount. It is further desirable to provide a consumer with additional long-term saving suggestions, such as when to upgrade a device to a more energy efficient model.

### SUMMARY

The present disclosure enables energy consumers to maintain comfort, reduce energy usage and costs by providing methods, systems and devices that will guide the user to make educated, logical choices regarding energy tradeoffs based on their actual usage patterns. Not only will these choices In addition to impacting a user's overall energy usage, the energy tradeoff choices will also impact the load on the electrical grid will also be impacted.

In accordance with one aspect of the present disclosure, a home energy management system for providing energy usage and cost projections to a user related to management of a home network is provided. The system comprises a central controller coupled to at least one energy consuming device. The central controller is configured to receive energy consumption data from the at least one energy consuming device. The system further includes a user interface comprising a display coupled to the central controller to receive user input data and provide the user with information. The central controller is further configured to use the energy consumption data and user input data to provide the user with one or more of future energy consumption projections, energy saving suggestions, and cost saving suggestions.

In accordance with another aspect of the present disclosure, a method is disclosed for providing energy usage and cost projections to a user related to the management of a home network via a user interface display coupled to a central controller. The method includes communicatively coupling the central controller to one or more energy consuming devices and associated utility, receiving one or more of energy consumption data from the at least one energy consuming device and utility data indicative of the current state of the associated utility, constructing an interactive diagram of the home network that includes selectable icons corresponding to each energy consuming device of the home network, and providing the user with an energy analysis of each selected icon. Each icon may be customized using a selection of parameters.

In accordance with yet another aspect of the present disclosure, a method is disclosed for establishing an energy management system having a home energy manager (HEM), at least one energy consuming device in communication with the HEM, and a user interface communicatively coupled to the HEM for providing user information and receiving user commands thereat. The method comprises the steps of collecting and analyzing energy consumption and constraint data that includes one or more of device parameters, device usage, energy state of a current utility, and energy cost data, extrapolating the data to provide future energy use and cost projections, and presenting the projections to a user via the user interface, and providing the user suggestions and tips for implementing energy and cost saving solutions.

### BRIEF DESCRIPTION OF THE DRAWINGS

FIG. 1 is a schematic illustration of an exemplary energy management system with one or more devices in accordance with one aspect of the present disclosure;

FIG. 2 is an illustrative depiction of an exemplary home network diagram including one or more devices in accordance with another aspect of the present disclosure;

FIG. 3 is another illustrative depiction of an exemplary home network diagram including a pop-up screen in accordance with another aspect of the present disclosure; and

FIG. 4 is a flow diagram illustrating an exemplary methodology for a home energy manager in accordance with yet another aspect of the present disclosure.

### DETAILED DESCRIPTION

A home energy management system is provided with a home energy manager (HEM) that can handle the energy management between utilities and a home network of power consuming devices. The HEM is an electronic system having a central controller that provides a homeowner the means to monitor and manage their energy consumption through a combination of behavior modification and programmed control logic. The central controller provides real time feedback on electricity, water, and natural gas consumption, and provides data on renewable energy generation occurring at the home, such as solar photovoltaic generation, wind generation, or any other type of renewable generation. The central controller can also receive and process a signal indicative of one or more energy parameters or operating states of an associated utility, including at least a peak demand state or period and an off-peak demand state or period.

The HEM system stores consumption data and communicates this data to homeowners. According to a first embodiment, the central controller operates as a data server for providing data through an application programming interface (API) in a client application, such as, for example, “Google PowerMeter”, which accesses data using a client application to acquire data from a web server. The API can then be used to present this data to the homeowner. The API generates graphs of energy usage, generation and/or storage on the client device, such as a personal computer, smart phone, or other remote device capable of displaying such graphs, that is in communication with the central controller. In another embodiment, data pertaining to the consumer's energy consumption, generated energy, and/or storage is displayed on a user display, such as an LCD touch screen display, to receive and present data through a web browser on the homeowner's networked PC. For example, energy data may be displayed on the device's user display and through a web browser on the homeowner's networked PC, mobile phone, or other device in communication with the central controller.

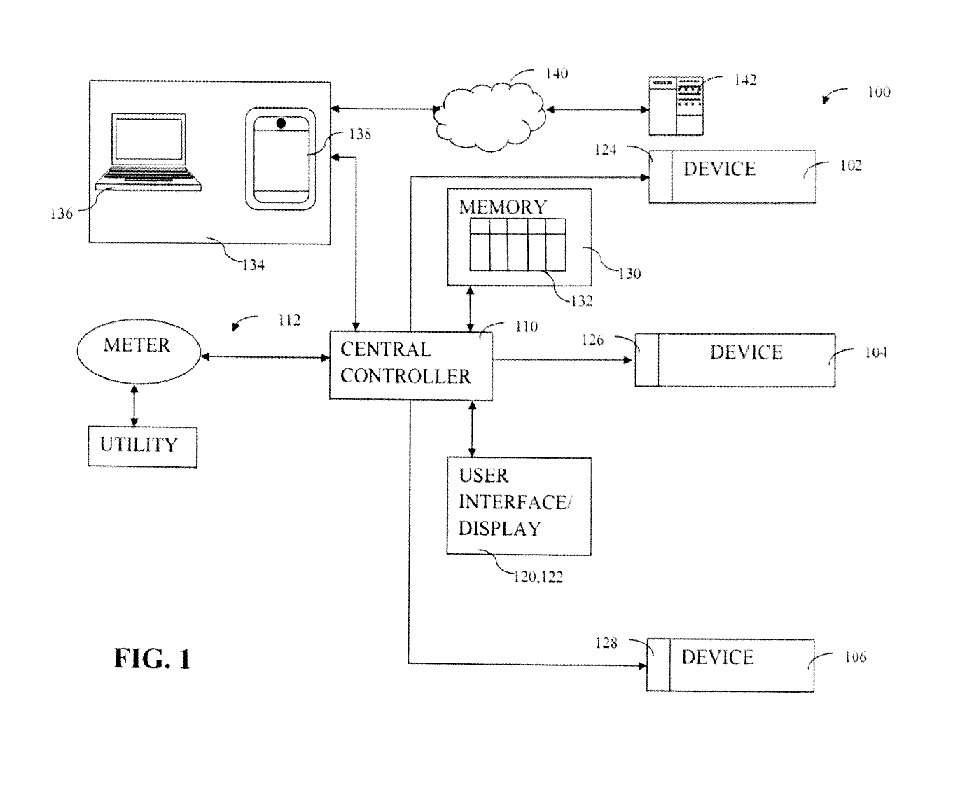

FIG. 1 schematically illustrates an exemplary home management system 100 for one or more energy consuming devices, such as devices 102, 104, 106 as is presently known. Each of the devices 102, 104, 106 can comprise one or more power consuming features/functions. For example, device 104 can be a refrigerator, an HVAC system, and/or any energy consuming device capable of having power consumption measured thereat. Such devices typically each have an internal controller which controls each of the device's power consuming features/functions. The controller 110 is operatively connected to each of the internal controllers. Alternatively, a DSM module may be hard wired to communicate with one or more of the internal controllers and receive an RF signal directly from the central controller. When operating as a HEM, the central controller 110 may transmit signals received from the utility (via smart meter or other means) along to devices, such as appliances 102, 104, and 106 connected to a home area network (HAN). The central controller 110 may determine which devices shed load by going into an energy savings mode or other power deferred state, or the central controller may communicate the occurrence of a peak demand condition or state to DSM modules which determine features/functions of its associated device are altered to shed load, or the signal from the central controller may be communicated to the internal controllers of the devices in the network.

The controller 110 may include a user interface 120 having a display 122. The display may include an LCD touch screen for enabling use interaction and input regarding what information is displayed, or the user interface 120 can include separate control buttons for making various operational selections. The controller 110 is configured to gather information and data related to current usage patterns and as well as current power costs, and generate historical usage charts therefrom. This information can be used to determine current energy usage and cost associated with using each device/appliance in at least one of the energy savings mode and normal mode. This real-time information (i.e., current usage patterns, current power cost and current energy usage/cost) can be presented to the user via the display.

The devices 102, 104, and 106 may additionally transmit instantaneous energy/power consumption information to the central controller 110. The controller 110 comprises a memory 130 having at least table 132 of FIG. 1 that collects energy consumption, generation and/or storage data for a home or other network (e.g., warehouse, business, etc.). The table comprises variables associated with the heating and cooling conditions of the home, for example. A table may be generated for each device and any given operating mode that includes historical home data that is currently updated and future projected data, which may be used in a client application of a client device, such as a computer or mobile phone, for presenting graphs or other data to the user.

In accordance with one aspect of the present disclosure, a home energy management system's central controller, operating as a HEM, extrapolates the information provided by the power consuming devices of the home network and or the utilities, or energy providers alike, for providing energy projections and energy saving suggestions to a homeowner. By extrapolating the energy data, the central controller can provide calculated projections related to potential cost savings suggestions and the implementation of green options, such as peak energy consumption reduction, carbon savings, and the like.

The HEM systems is configured to utilize the display of the user interface to provide active, real-time feedback to the user regarding the implications of operating each device 102, 104, 106 under a variety of circumstances, such as time of day and type of usage. One such implication is the cost to the user of using a particular device in a particular manner. Energy costs are generally based on the current operating and usage patterns and energy consumption costs, such as the cost per kilowatt hour charged by the corresponding utility or energy provider. The central controller can review the energy usage of an entire home network relative to each device controlled by the HEM system and determine the impact of each decision made regarding response choices within the home network before the actual decision is executed. The type of information to be provided to the user may include the impact that a particular decision will have on the electric bill, the peak demand impact, the carbon footprint impact, or any other metric of the like.

As described above, the central controller is configured to receive information indicative of the current energy state of a utility or associated energy provider. When the controller receives input that a peak demand period is approaching, this information can be presented to a user on the user interface display, along with a notification of any home network devices in use and scheduled to enter energy saving mode for the duration of the peak period. Based on this knowledge, a user can decide to allow one or more device(s) to enter energy saving mode, override the decision to enter energy saving mode, delay the start of the device, or completely disable the device. The controller could present “all possible options” available to the user in one page either graphically or tabular such that the user could make the best choice considering all possible options. The user may select each option for each device in question and the controller can calculate various cost projections based on the responses and display such cost projections to the user. The selection of each option will impact cost displayed and thus the user can visualize the just how each decision will energy usage and cost.

The central controller of the HEM system is further configured to track the energy consumption of a particular home network device for a given cycle and record any changes in this consumption during a peak demand period. For instance, a refrigerator provides feedback to the central controller indicating that during a peak demand period, the refrigerator consumed x amount of power, compared to a period of time immediately prior to, or immediately after, the peak event, in which the refrigerator consumed y. The controller can then include this information in a graph or database that depicts what the refrigerator, or other home network device, typically consumes in one cycle, over the last ten cycles, the last twenty cycles, etc. A cycle may be defined as the elapsed time between a start of an appliance and the stop of the same appliance. Likewise, it could be defined as a specific elapsed time, such as a 24 hour period. This graph or database may be displayed to a homeowner on the display screen of the user interface.

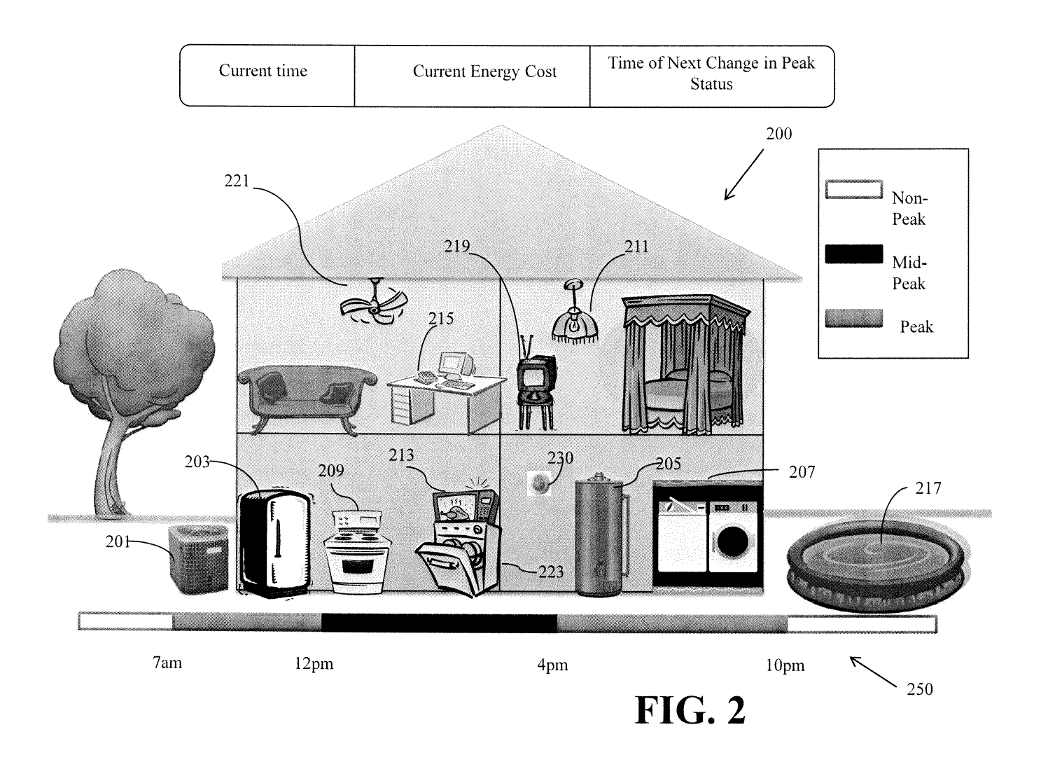

Based at least upon the information collected and stored in the central controller, an interactive map/diagram is developed that simulates the layout of a user's home network, including each home network device and display this interactive diagram to the user, as best illustrated in FIG. 2. According to this illustrative embodiment, the diagram 200 includes selectable icons representing each of a home network's energy consuming devices, such as an air conditioning unit 201, a refrigerator 203, a water heater 205, a washer/dryer 207, a stove 209, lights 211, a microwave 213, a computer 215, a pool with a pool pump 217, a television 219, a ceiling fan 221, and a dishwasher 223. The diagram 200 is preferably interactive, wherein a user can manipulate device and usage variables specific to each device to present different situations and outcomes. Each device icon depicted in the diagram may be individually selected and manipulated to create a visualization of how much it will cost to run the selected device for a particular period at a particular time of day. The central controller is in communication with each device by way of a RF connection. Additionally, the communications module attached to each device incorporates an address which is associated with that device, thereby allowing the central controller to recognize each device specifically.

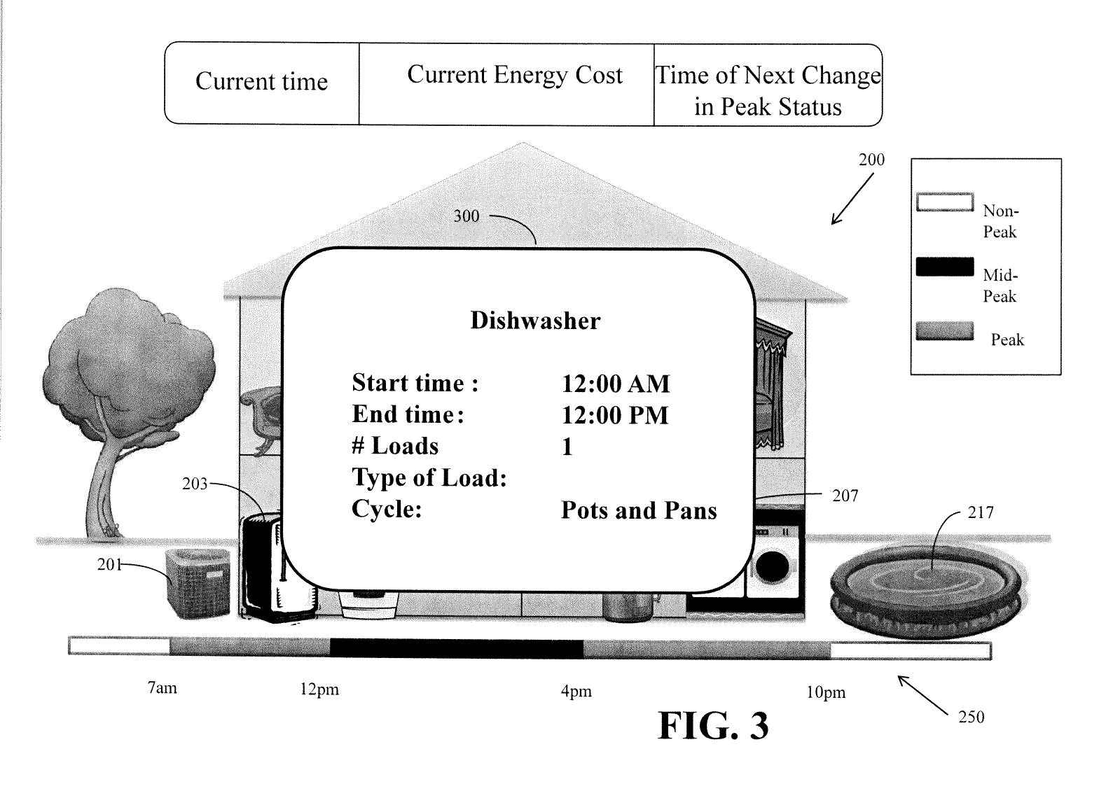

With reference to FIG. 3, selecting a device icon, such as the dishwasher 223, triggers a pop-up screen 300 requesting that a user specify usage parameters, such as start time, number of loads, type of load cycle, etc. Upon entering the information, the usage cost for each scenario is calculated and displayed to the user to illustrate the various effects each decision a user makes. The user can return to the main diagram screen 200 at any time and adjust any or all of the parameters and compare the effects various decisions have on cost and energy usage. The user may choose to switch to another device and/or switch to another time of day/night. The cost calculated as a result of the selected parameters can be added to calculated costs of other devices to create a daily, weekly, monthly, or yearly household prediction. A timeline 250 may be continuously provided on the screen, indicating times of peak, mid-peak, non-peak and any other desired peak demand periods to allow users to visualize the changes on costs based on the designated utility state.

With further reference to FIG. 3, and in accordance with one example, a user consults the diagram 200 intending to run a laundry wash cycle at 6 pm. The timeline 250 of the diagram 200 indicates to the user that the utility is currently experiencing a peak demand period, which is scheduled to terminate at 10 pm. The user can select the icon for each of the washer and dryer separately on the diagram, enter usage parameters, and compare the cost of running the washer and dryer at 6 pm and at 10 pm. The diagram will illustrate to the user that delaying the wash cycle until after 10 pm would likely result in a savings of x amount of money. Since delaying a wash cycle necessarily delays a drying cycle, which may result in a savings of y amount of money, the application will calculate a total saving of x+y. Each parameter entered for a specific wash/dry usage, such as the number of loads, wash and/or dry cycle setting, the desired water temperature, etc., will affect the outcome of the cost. Preferably, the user also inputs the water heating means, such as gas, electric, or hybrid electric. This knowledge will facilitate more accurate cost projections based on the amount of hot water consumed during a wash cycle. Combining this knowledge with knowledge of the cycle parameters used, i.e., hot water wash or cold water, will enable more accurate projections. The HEM may then make suggestions to the user on how to further lower the calculated costs, by adjusting usage parameters such as time, water temperature, etc.

The same methodology may be applied to each device in the home network, such as an oven, refrigerator, HVAC, etc. In terms of an oven, depending on the time of day/night, type of cooking to be done, length of time the oven will be on, desired temperature, oven setting, etc., the central controller can calculate the cost of cooking one or more particular items. Using this cost, a user can determine if for example, it would be more cost effective to cook as planned, alter cooking plans such as utilizing a microwave oven to reheat or heat pre-cooked foods, or purchase pre-cooked “ready to eat” food at a grocery store or restaurant. Not only is the controller equipped to acquire the cost of pre-cooked food items for comparative purposes, but the user may be educated as to the specific cost of cooking the food. The user can then factor this information into the decision of buying a pre-cooked meal versus cooking at home. Additionally, the controller could present the cost of “warming” a pre-cooked frozen meal in the microwave, assuming that the user inputs the cooking time required for the specific meal.

In another aspect of the present disclosure, the controller 110 connects via either Ethernet or WiFi to the user's router for accessing the Internet 140 of FIG. 1. Based on the specifications of each device in the user's home network stored in the controller, a user may be presented with suggestions regarding upgrading or improving one or more devices in the home network, such as suggestions pertaining to more energy efficient devices. For instance, a user may input available specifications for any or all of the devices included in the home network. The specifications may include information such as the model number, year, etc., that is easily obtained from device literature, product labels and the like. Based on the inputted specifications, the controller can identify one or more upgraded energy efficient devices that could potentially save the user money. Based on the patterns of past usage for a particular device, a projection of a user's cost of using the device can be estimated over a particular time period, such as a week, month, year, and this projected cost can be compared to the cost of purchasing and running an updated device in the same manner over the same period of time. This comparison may provide “payback information” to demonstrate that replacing the device is more cost effective to a user, especially over some specified payback period.

A similar analysis may be implemented for analyzing a user's HVAC energy usage as defined in U.S. application Ser. No. 12/837,741, fully incorporated herein by reference. This analysis may then be used for comparing to other homes via a network, such as a social network The central controller can track and analyze the amount of power the HVAC consumes for a given day, month, year, etc. For instance, during a peak demand period the temperature set point in a home may be raised from 74° F. to 78° F., causing the air conditioner to shut off. The central controller can track the time it takes for the house to increase in temperature 4° F. Since the controller also knows the outdoor temperature, the system can build a family of cool-down curves with specific indoor setpoints and outdoor temperature, as further defined in detail in U.S. application Ser. No. 12/837,741. Once the peak demand event is over, and the temperature set point is returned to 74° F., the central controller can track the time it takes the air conditioner to bring the temperature back down and may build an analogous family of curves for the cool-down period. Inferences regarding the health of the HVAC system and the thermal efficiency of the house structure can be devised and presented to the homeowner by the system. Additionally, the user may enter as many parameters of the HVAC as available, such as model number, year, serial number, average temperature when in use, cost to run over a particular period, such as the past month, year, etc. This information may further be used to assess the efficiency of and cost to operate the HVAC system and these parameters may be compared with that of an upgraded, more energy efficient HVAC. Moreover, better tradeoff analyses will result if the user is able to input thorough, specific product specifications such as EER, SEER, capacity, etc. for example of the current HVAC system. The purpose of providing such information is to make the application's estimates more educated and accurate; however, some useful information can be presented to the homeowner from the ramp-up and cool-down data as described earlier.

Preferably, for implementing the aforementioned upgrade suggestions and comparisons, the controller is configured to locate available device upgrades automatically by populating the device specifications and accessing a General Electric (GE) or an affiliated website or database including a catalog of comparable devices. If, however, the selected device is a product that is not manufactured and/or sold by GE, such as central air conditioner, for example, the controller can access other manufacture models and the energy efficiency rating (EER) of those products from various sites online. In the case of non-GE devices, a user may have to provide more device information to obtain more accurate comparisons and suggestions. Likewise, the controller may be able to link to a General Electric website to gleen the specific performance data for their current HVAC system for use in the comparison with newer equipment.

The central controller is further configured to provide suggestions to a homeowner for improving the overall efficiency of the homeowner's home for saving on heating, cooling, and other energy costs. U.S. application Ser. No. 12/837,741, fully incorporated by reference herein, provides a method for recording the thermal characteristics and time response constraints of an individual home to suggest behaviors that can be used with TOU or DR programs to reduce the total energy, peak load, and costs to residential energy consumers. A controller gathers data of a particular home and builds a home profile based upon these specific conditions. The presently disclosed HEM system utilizes this information that is collected and stored in the controller to further assess a home's efficiency status. The HEM system is configured to consider pertinent variables such as the efficiency of the insulation, the windows, etc., and can provide tips and suggestions for implementing improvements that will improve efficiency. A user may be requested to input home specifications, such as size, materials used, year built, insulation type and thickness in walls and ceilings, window configurations, home orientation etc., to provide an accurate view of the home. The more inputs a user provides the more accurate analysis and suggestions for improvement will be. The controller can incorporate an analysis program that calculates the heating and cooling loads for the specific house based on these inputs and/or assumed factors based on the age of the home, location, and common building practices for that era in this locale. Alternatively, if a user prefers not to input data manually, the controller may gather as much information as possible from the actual utility meter, since, as mentioned above, the controller is tied to the meter.

According to another aspect, the HEM system is configured to analyze and assess a home network's lighting system. A user may input the number of lighting units found in each room, the type of lights, the wattage of each light, when the lights are on, etc., and the controller can calculate how much of an energy load this adds to the system when the lights are in use. Additionally, the subject application can indicate how much a user will save if the current lights were replaced by more energy efficient lights. ASHRAE has very effective and detailed transfer functions that will predict the impact of lighting on cooling loads as well as the direct power consumption of lighting devices. These algorithms can be incorporated into the HEM system to facilitate the inclusion of lighting tradeoffs into the cooling costs of a building.

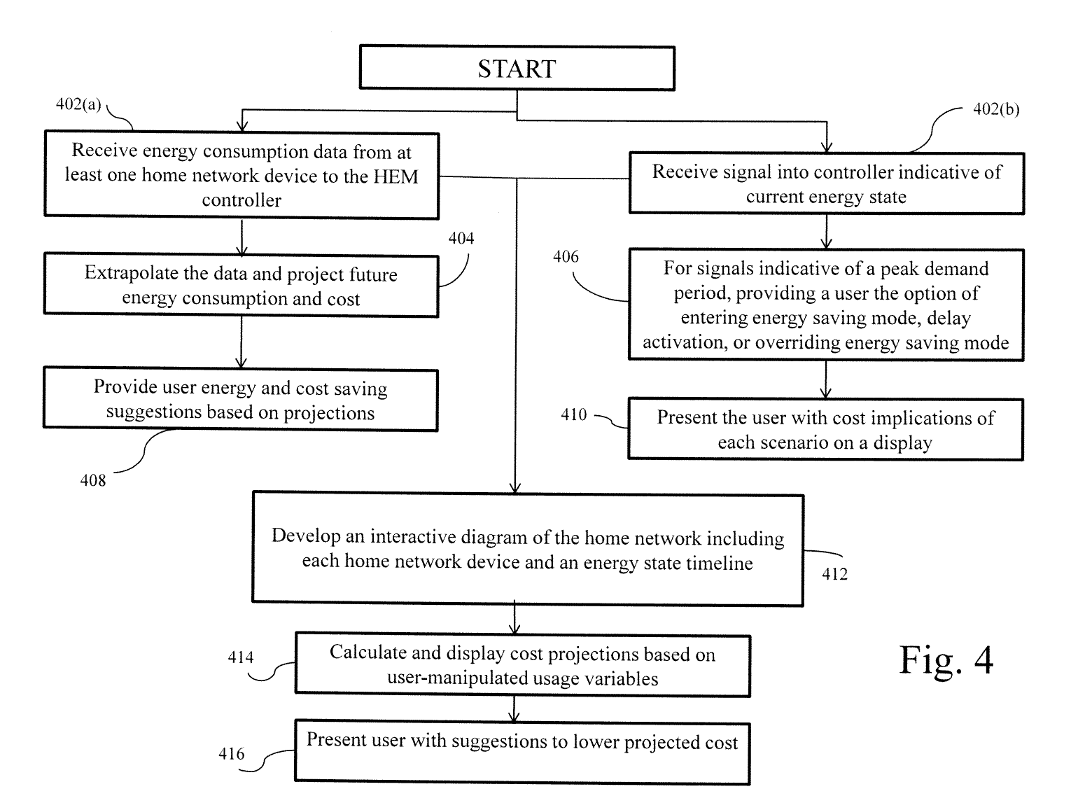

FIG. 4 illustrates an exemplary method 400 for implementing the HEM system methodology provided herein. While the method 400 is illustrated and described below as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

The method 400 begins at START. At 402(a) energy consumption data signals are sent from at least one energy consuming device in a home network to a central controller of a home energy management system (HEM). The energy consuming devices comprise, for example, an HVAC, a refrigerator, a dishwasher, a dryer and any other power consuming device configured to operate at power levels detected by a power/energy measuring device, such as pool pumps, thermostats, and/or smart switches. At 404 the controller is utilized to extrapolate the energy consumption data and project future energy consumption and costs. At 408, the user is provided with energy costs saving suggestions based on the projected future energy consumption and costs calculated in 404.

Additionally, at 402(b), the controller receives signals from an associated utility indicative of the utility's energy state, such as a peak demand period, a non-peak demand period, and a mid-peak demand period. For signals indicative of a peak demand period, at 406, a user is presented with the option to enter energy saving mode, delay device activation, or override energy saving mode. At 410, the user is presented with cost implications for each scenario on a display. Many utilities use repetitive or recurring price tiers that repeat on a daily basis. Additionally, the daily tiers are adjusted according to season, such that a utility may have a summer period of tiers, a winter period of tiers, etc. In these cases, the user could be presented the cost implications of various decisions hours or days before an event is to occur. This would allow for more thought time to process the ramifications before making a choice or decision.

Furthermore, at 412, the HEM develops an interactive diagram of the home network including each home network device and an energy state timeline. At 414, the HEM calculates and displays cost projections based on user-manipulated user variables, such as length of use, time of use, type of use, etc. At 416, the user is presented with suggestions as to methods of lowering the projected costs.

The invention has been described with reference to the preferred embodiments. Obviously, modifications and alterations will occur to others upon reading and understanding the preceding detailed description. It is intended that the invention be construed as including all such modifications and alterations.

1. A home energy management system for providing energy usage and cost projections to a user related to management of a home network, said system comprising:
a central controller coupled to at least one energy consuming device, said central controller being configured to receive energy consumption data from said at least one energy consuming device; and
a user interface comprising a display coupled to the central controller to receive user input data and provide said user with information, wherein said central controller is further configured to use the energy consumption data and user input data to provide said user with one or more of future energy consumption projections, energy saving suggestions, and cost saving suggestions.

2. The home energy management system according to claim 1, wherein said controller is further configured to receive utility data indicative of the current state of an associated utility and use said utility data along with said energy consumption data and said user input data to provide said future energy consumption projections, energy savings suggestions and cost saving suggestions.

3. The home energy management system according to claim 2, wherein based upon said controller received data, the controller is configured to develop an interactive diagram of said home network and display said diagram to a user.

4. The home energy management system according to claim 3, wherein said interactive diagram includes said at least one energy consuming device in said network.

5-7. (canceled)

8. The home energy management system according to claim 1, wherein said central controller is a home energy manager.

9. (canceled)

10. The home energy management system according to claim 1, wherein said at least one energy consuming device comprises an HVAC, a refrigerator, a dishwasher, a dryer and any other device or power switch or energy consuming device.

11. The home energy management system according to claim 1, wherein said controller includes an analysis program configured to calculate energy loads for a particular home based on at least one of home specifications provided by a user and assumed factors of the home.

12. (canceled)

13. A method for providing energy usage and cost projections to a user related to the management of a home network comprising a central controller communicatively coupled to one or more energy consuming devices, a user interface display and an associated utility, said method comprising:
collecting energy consumption data from said at least one energy consuming device and utility data indicative the current state of said associated utility;
constructing an interactive diagram of the home network, wherein said diagram includes selectable icons corresponding to each energy consuming device of said home network, wherein each icon may be customized using a selection of parameters; and
providing said user with an energy analysis of each selected icon.

14. The method according to claim 13, wherein said energy analysis includes projecting future energy cost and consumption based at least in part on said received data and said selected energy consuming device parameters.

15. The method according to claim 13, further including presenting said energy projections to a user on a user interface display.

16. The method according to claim 13, wherein said energy cost and consumption projections include one or more of future energy consumption, future energy cost, energy saving suggestions, and cost saving suggestions.

17. The method according to claim 13, wherein said parameters include time of use, length of use, desired power level, desired temperature, and any additional parameters that may affect energy consumption.

18. The method according to claim 13, wherein the selecting various combinations of energy consuming device parameters provides a visual comparison of the effect each parameter has on energy usage cost.

19. The method according to claim 13, further including providing a comprehensive energy analysis for the entire home network.

20. The method according to claim 13, further including creating an internet connection between said controller and a database containing energy consuming devices.

21. The method according to claim 20, further including:
comparing the projected future energy usage cost of at least one energy consuming device with the cost of and projected future usage cost of a more efficient energy consuming devices located on said database; and
displaying the comparison to the user.

22. The method according to claim 13, wherein a user may input specifications for the at least one energy consuming device to increase accuracy of the energy analysis, said specifications including one or more of serial number, model number, and year.

23. The method according to claim 13, wherein the controller is configured to automatically detect the specifications for the at least one energy consuming device.

24. The method according to claim 13, wherein said at least one energy consuming device comprises an HVAC, a refrigerator, a dishwasher, a dryer and any other device or power switch or energy consuming device configured to operate at power levels detected by an associated power/energy measuring device.

25. A method for enabling a user to visualize the impact of energy usage decisions in a home network comprising a central controller communicatively coupled to one or more energy consuming devices, a user interface display and an associated utility, said method comprising:
collecting and analyzing energy consumption data, wherein said data includes one or more of device parameters, device usage, energy state of a current utility, and energy cost data;
using said data to provide future energy use and cost projections and presenting said projections to a user via said user interface; and
providing suggestions for saving energy and reducing cost.
